(19) United States
(12) Patent Application Publication
(10) Pub. No.: US 2024/0336480 A1
(43) Pub. Date: Oct. 10, 2024

(54) METHOD OF PRODUCING SPHERICAL SOLID ELECTROLYTE

(71) Applicants: Hyundai Motor Company, Seoul (KR); Kia Corporation, Seoul (KR); Hansol Chemical Co., Ltd., Seoul (KR)

(72) Inventors: In Woo SONG, Gwacheon-si (KR); Hong Seok MIN, Yongin-si (KR); Wo Dum JUNG, Seoul (KR); So Young KIM, Jeongeup-si (KR); Sang Soo LEE, Goyang-si (KR); Sang Heon LEE, Yongin-si (KR); Seul Ki CHOI, Wanju-gun (KR); Chang Min CHO, Wanju-gun (KR); Woo Seop SONG, Wanju-gun (KR); Young Sung LEE, Wanju-gun (KR); So Young YOON, Wanju-gun (KR); Se Man KWON, Wanju-gun (KR); Yung Sup YOUN, Wanju-gun (KR)

(21) Appl. No.: 18/529,132

(22) Filed: Dec. 5, 2023

(30) Foreign Application Priority Data
Apr. 7, 2023 (KR) 10-2023-0045915

(51) Int. Cl. C01B 17/40; H01M 10/0562

(52) U.S. Cl. CPC C01B 17/40; H01M 10/0562; C01P 2004/03; C01P 2004/51; C01P 2004/61; C01P 2006/11; C01P 2006/40; H01M 2300/0068

(57) ABSTRACT

The present disclosure relates to a method of producing a solid electrolyte with a uniform particle size distribution and a spherical shape. The method includes preparing a raw material comprising one or more of a lithium (Li) element, a phosphorus (P) element, or a sulfur(S) element, preparing a starting material comprising the raw material and a solvent, obtaining an intermediate in powder form by spray drying the starting material, and obtaining a sulfide-based solid electrolyte by heat treating the intermediate.

### CROSS-REFERENCE TO RELATED APPLICATION

This application claims under 35 U.S.C. § 119 (a) the benefit of priority to Korean Patent Application No. 10-2023-0045915 filed on Apr. 7, 2023, the entire contents of which are incorporated herein by reference.

### TECHNICAL FIELD

The present disclosure relates to a method of producing a solid electrolyte having a uniform particle size distribution and a spherical shape.

### BACKGROUND

The particle shape of the sulfide-based solid electrolyte varies depending on the drying time, temperature, and pressure. For example, since the quantity of evaporation of sulfur in the precursor solution increases as the drying time increases, it may be difficult to control the particle size distribution and shape of the sulfide-based solid electrolyte. Therefore, there is a need for designing a process which enables the sulfur loss minimization by proceeding with the drying within a short time in an appropriate temperature range.

Meanwhile, when the sulfide-based solid electrolyte comes into contact with moisture and/or oxygen, an oxidation reaction thereof occurs very quickly. This causes deformation of the particles of the sulfide-based solid electrolyte and a change in the composition ratio.

As a result, in the sulfide-based solid electrolyte synthesized by the general method, a mixture of spherical and plate-shaped particles exists, and powders having fine and large particle sizes are also mixed. When a slurry is produced using a sulfide-based solid electrolyte whose particle size and shape are not controlled as described above, viscosity can change over time, which can in turn result in poor dispersibility of components.

### SUMMARY OF THE DISCLOSURE

An object of the present disclosure is to provide a method of producing a sulfide-based solid electrolyte having a spherical shape and a uniform particle size distribution.

The objects of the present disclosure are not limited to the one described above. The objects of the present disclosure will become further apparent by the following description, and will be realized by means and combinations thereof recited in the claims.

A method of producing a solid electrolyte according to the present disclosure may include preparing a raw material including at least one selected from the group consisting of a lithium (Li) element, a phosphorus (P) element, a sulfur(S) element, and combinations thereof, preparing a starting material including the raw material and a solvent, obtaining an intermediate in powder form by spray drying the starting material, and obtaining a sulfide-based solid electrolyte by heat treating the intermediate.

The raw material may include Li₂S and P₂S₅. The raw material may further include a lithium compound including a halogen element. The solvent may include tetrahydrofuran (THF). The starting material may have a solid content in an amount of 10% by weight to 30% by weight.

The obtaining of the intermediate may include spraying the starting material into a chamber of a spray dryer through a nozzle atomizer. The quantity of evaporation of the chamber may range from 1 kg/hr to 4 kg/hr. The obtaining of the intermediate may include spraying the starting material into the chamber at the quantity of spray of 50 ml/min to 70 ml/min. The internal pressure of the chamber may range from 1.3 atm to 1.5 atm.

The spray dryer may include a chamber having an internal space of a certain size, a nozzle atomizer connected to the chamber to spray the starting material, a first compressor connected to the nozzle atomizer to supply a carrier gas, a second compressor connected to the chamber to supply a gas for adjusting the internal pressure of the chamber, a sensor mounted in the chamber to measure the internal pressure of the chamber, a vent valve for discharging the carrier gas in the chamber to the outside; and a controller which is connected to the second compressor and the vent valve to control whether to operate the second compressor and the vent valve or not based on the internal pressure of the chamber measured by the sensor.

The obtaining of the intermediate may be performed in a temperature of 180° C. to 240° C. The obtaining of the intermediate may include spray drying the starting material for 1 second to 5 seconds. The obtaining of the sulfide-based solid electrolyte may include heat treating the intermediate in a temperature of 300° C. to 500° C. for 12 hours to 48 hours.

When the 50% cumulative mass particle size distribution diameter in the particle distribution of the sulfide-based solid electrolyte is referred to as D50, the D50 of the sulfide-based solid electrolyte may range from 5 μm to 10 μm. When the 90%, 50%, and 10% cumulative mass particle size distribution diameters in the particle distribution of the sulfide-based solid electrolyte are referred to as D90, D50, and D10, respectively, (D90-D10)/D50 of the sulfide-based solid electrolyte may range from 1 to 3.

A tap density of the sulfide-based solid electrolyte may range from 0.5 g/ml to 0.7 g/ml. The pellet density of the sulfide-based solid electrolyte may range from 1.65 g/ml to 1.8 g/ml.

According to the present disclosure, a sulfide-based solid electrolyte having a spherical shape and a uniform particle size distribution can be obtained.

The effects of the present disclosure are not limited to the aforementioned effects. It should be understood that the effects of the present disclosure include all effects that can be inferred from the following description.

### BRIEF DESCRIPTION OF THE DRAWINGS

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 shows an example method of producing a solid electrolyte according to the present disclosure;

FIG. 2 shows an implementation of an example spray dryer according to the present disclosure;

FIG. 3 shows an implementation of an example nozzle atomizer of the present disclosure.

FIG. 4 shows an example result of observing the sulfide-based solid electrolyte according to Example 1 with a scanning electron microscope;

FIG. 5 shows an example result of observing the sulfide-based solid electrolyte according to Example 2 with a scanning electron microscope;

FIG. 6 shows an example result of observing the sulfide-based solid electrolyte according to Example 3 with a scanning electron microscope;

FIG. 7 shows an example result of observing the sulfide-based solid electrolyte according to Example 4 with a scanning electron microscope;

FIG. 8 shows an example result of observing the sulfide-based solid electrolyte according to Comparative Example 1 with a scanning electron microscope;

FIG. 9 shows an example measurement result of the particle size distribution of the sulfide-based solid electrolyte according to Example 1;

FIG. 10 shows an example measurement result of the particle size distribution of the sulfide-based solid electrolyte according to Example 2;

FIG. 11 shows an example measurement result of the particle size distribution of the sulfide-based solid electrolyte according to Example 3;

FIG. 12 shows an example measurement result of the particle size distribution of the sulfide-based solid electrolyte according to Example 4;

FIG. 13 shows an example measurement result of the particle size distribution of the sulfide-based solid electrolyte according to Comparative Example 1;

FIG. 14 is an example cyclic voltammetry evaluation result of the performances of all-solid-state batteries manufactured using the sulfide-based solid electrolytes according to Examples 1, 2, and Comparative Example 1;

FIG. 15 shows example capacities measured while charging and discharging all-solid-state batteries manufactured using sulfide-based solid electrolytes according to Examples 1, 2, and Comparative Example 1;

FIG. 16 is a result of analyzing the sulfide-based solid electrolyte according to Comparative Example 5 with a scanning electron microscope;

FIG. 17 shows an example result of analyzing the sulfide-based solid electrolyte according to Comparative Example 6 with a scanning electron microscope;

FIG. 18 shows an example measurement result of the particle size distribution of the sulfide-based solid electrolyte according to Comparative Example 5; and

FIG. 19 shows an example measurement result of the particle size distribution of the sulfide-based solid electrolyte according to Comparative Example 6.

### DETAILED DESCRIPTION

The aforementioned objects, other objects, features and advantages of the present disclosure will be easily understood through the following preferred implementations in conjunction with the accompanying drawings. However, the present disclosure is not limited to the implementations described herein, but may be embodied in other forms. Rather, the implementations introduced herein are provided so that the disclosed contents can be thorough and complete, and that the technical idea of the present disclosure can be sufficiently conveyed to those skilled in the art.

Unless otherwise specified, all numbers, values and/or expressions used herein to express quantities of ingredients, reaction conditions, polymer compositions and compounds are to be understood as being modified in all instances by the term “about”, since, among others, these numbers are essentially approximations which reflect the various uncertainties of the measurements that take place in obtaining these values. Also, when numerical ranges are disclosed in this description, such ranges are continuous and include all values between the minimum and the maximum (inclusive) of the ranges, unless otherwise indicated. Furthermore, when such ranges refer to integers, all integers between the minimum and the maximum (inclusive) are included, unless otherwise indicated.

FIG. 1 shows a method of producing a solid electrolyte according to the present disclosure. Referring to this, the producing method may include preparing a raw material including at least one selected from the group consisting of a lithium (Li) element, a phosphorus (P) element, a sulfur(S) element, and combinations thereof (S10); preparing a starting material including the raw material and a solvent (S20); obtaining an intermediate in powder form by spray drying the starting material (S30); and obtaining a sulfide-based solid electrolyte by heat treating the intermediate (S40).

Examples of the sulfide-based solid electrolyte may include Li₃PS₄, Li₆PS₅Cl, Li₆PS₅Br, Li₆PS₅I, and the like.

The raw material may be prepared according to the composition of the desired sulfide-based solid electrolyte (S10). For example, the raw material may include Li₂S and P₂S₅. Additionally, the raw material may further include a lithium compound including a halogen element. Examples of the lithium compound may include LiCl, LiBr, LiI, and the like.

The starting material may be prepared by mixing the raw material with the solvent (S20).

Any solvent may be used as long as it can disperse the raw material without being reacted therewith. For example, the solvent may include tetrahydrofuran (THF).

The starting material may have a solid content in an amount of 10% by weight to 30% by weight. If the solid content of the starting material is less than 10% by weight, the raw material may be ionized by the polarity of the oxygen element included in tetrahydrofuran, and so a sulfide-based solid electrolyte, which is the final product, may become a fine powder having a particle size of less than 1 μm, and non-uniform particle shapes. If the solid content of the starting material exceeds 30% by weight, the amount of the solvent is reduced, and so the dispersibility of the raw material may be lowered, and the aggregation thereof may occur.

By spray drying the starting material prepared as described by the use of a spray dryer, the intermediate in powder form can be obtained (S30).

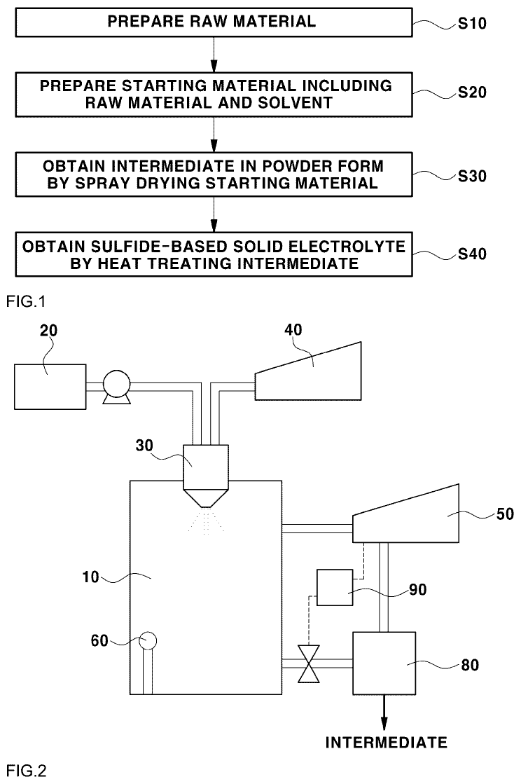

FIG. 2 shows an implementation of a spray dryer according to the present disclosure. The spray dryer may include a chamber 10 having an internal space of a certain size, a tank 20 for storing the starting material, a nozzle atomizer 30 for spraying into the chamber 10 the starting material supplied from the tank 20, a first compressor 40 connected to the nozzle atomizer 30 to supply a carrier gas, a second compressor 50 connected to the chamber 10 to supply a gas for adjusting the internal pressure of the chamber 10, a sensor 60 mounted on the chamber 10 to measure the internal pressure of the chamber 10, a vent valve 70 for discharging the carrier gas and the intermediate that has undergone the drying from the chamber 10 to the outside, a separator 80 for separating the materials discharged from the chamber 10 into the carrier gas and the intermediate, and a controller 90 for controlling whether to operate the second compressor 50 and the vent valve 70 or not.

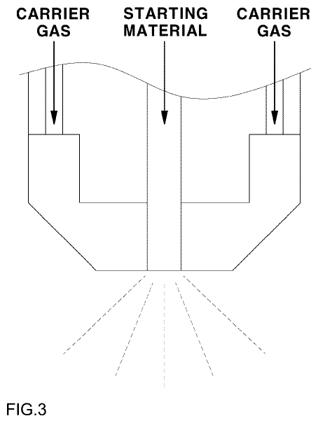

The present disclosure is technically characterized by the nozzle atomizer 30 being used to prepare a sulfide-based solid electrolyte having a uniform particle size. FIG. 3 shows an implementation of the nozzle atomizer 30 of the present disclosure. The starting material is finely sprayed and injected into the chamber 10 from the distal end of the nozzle by a carrier gas. Since the nozzle atomizer 30 has higher dispersibility than other atomizers such as disk atomizers, a sulfide-based solid electrolyte having a uniform particle size can be obtained. In addition, in the nozzle atomizer 30, since the sprayed material falls vertically during the drying, the drying time is short and the loss of sulfur of the starting material can be minimized, so that a high-quality sulfide-based solid electrolyte can be obtained.

The carrier gas is not particularly limited, and examples thereof may include an inert gas such as argon gas.

The present disclosure is characterized in that the spray amount of the starting material is adjusted to prepare a spherical sulfide-based solid electrolyte. First, the starting material may have a solid content of a range expressed by specific numerical values as mentioned above. Under the condition that the quantity of evaporation of the chamber 10 may range from 1 kg/hr to 4 kg/hr, the starting material may be sprayed into the chamber 10 at the quantity of spray of 50 ml/min to 70 ml/min. If the quantity of spray exceeds 70 ml/min, the drying may not be completed completely, and residual solvent may remain. The residual solvent may be carbonized and become impurities in a heat treatment process to be described later.

The present disclosure is characterized in that the internal pressure of the chamber 10 is kept constant in order to manufacture a sulfide-based solid electrolyte having a uniform particle size. In order to obtain an intermediate of uniform quality, the air flow and pressure should be kept constant throughout the spraying, the drying and the collection. A positive pressure is generated in the chamber 10 by the carrier gas used to spray the starting material into the chamber 10, and when the intermediate that has undergone the drying is discharged through the vent valve 70, a negative pressure is generated in the interior of the chamber 10. Therefore, unless the internal pressure of the chamber 10 is artificially adjusted, a sulfide-based solid electrolyte having a uniform particle size cannot be obtained because the pressure conditions within the chamber 10 change from moment to moment.

In the spray dryer according to the present disclosure, the controller 90 connected to the second compressor 50 and the vent valve 70 may operate the second compressor 50 and the vent valve 70 based on the internal pressure of the chamber 10 measured by the sensor 60, thereby adjusting the internal pressure of the chamber 10. Specifically, the controller 90 may adjust the internal pressure of the chamber 10 to be between 1.3 atm and 1.5 atm. When a positive pressure greater than necessary is generated in the chamber 10, the controller 90 opens the vent valve 70 to lower the internal pressure of the chamber 10. Additionally, when a negative pressure greater than necessary is generated in the chamber 10, the controller 90 drives the second compressor 50 to supply a gas to the chamber 10. The gas is not particularly limited, and the same gas as the carrier gas may be used.

The obtaining of the intermediate (S30) may be performed in a temperature of 180° C. to 240° C. The temperature may refer to a temperature within the chamber 10. If the temperature is less than 180° C., the drying time may become longer, which may make it difficult if not impossible to obtain a sulfide-based solid electrolyte having a uniform particle size.

The obtaining of the intermediate (S30) may include spray drying the starting material for 1 second to 5 seconds. The sulfur loss can be minimized when the drying time falls within the above range.

The intermediate which has undergone the drying is discharged through the vent valve 70 together with the carrier gas, other gas, and the like from the chamber 10, and is moved to the separator 80. Examples of the separator 80 may include any device capable of separating a solid and a gas. For example, the separator 80 may include a cyclone.

The intermediate separated by the separator 80 may be separately collected for heat treatment to be described later, and carrier gas, other gas, or the like can be supplied to the second compressor 50 to be used as a gas for adjusting the internal pressure of the chamber 10.

A sulfide-based solid electrolyte can be obtained by heat treating the obtained intermediate as described above (S40). Through the heat treatment, the intermediate can be crystallized and impurities can be removed. Specifically, the sulfide-based solid electrolyte may be obtained by heat treating the intermediate in a temperature of 300° C. to 500° C. for 12 hours to 48 hours.

The sulfide-based solid electrolyte is characterized by its uniform spherical particle size.

When the 50% cumulative mass particle size distribution diameter in the particle distribution of the sulfide-based solid electrolyte is referred to as D50, the D50 of the sulfide-based solid electrolyte may range from 5 μm to 10 μm. The D50 may refer to a particle diameter when cumulative frequency becomes 50% as the number of particles is accumulated from the smaller particle diameter. If the D50 is less than 5 μm, the packing density of the sulfide-based solid electrolyte may decrease when an electrode and/or a solid electrolyte layer is manufactured using the sulfide-based solid electrolyte. If the D50 exceeds 10 μm, the specific surface area of the sulfide-based solid electrolyte is reduced and the interface with the active material or the like is reduced, and accordingly, the lithium ion conductivity of the electrode and/or the solid electrolyte layer may decrease.

When the 90%, 50%, and 10% cumulative mass particle size distribution diameters in the particle distribution of the sulfide-based solid electrolyte are referred to as D90, D50, and D10, respectively, (D90-D10)/D50 of the sulfide-based solid electrolyte may range from 1 to 3. The D10 may refer to a particle diameter when cumulative frequency becomes 10% as the number of particles is accumulated from the smaller particle diameter. The D90 may refer to a particle diameter when cumulative frequency becomes 90% as the number of particles is accumulated from the smaller particle diameter. The (D90-D10)/D50 is an index for measuring the particle size distribution width, and as it becomes closer to 0, the particle size distribution width is considered narrower.

The means for obtaining said D50, D90, or D10 is not particularly limited, but can be obtained, for example, from integrated volume value measured with a laser beam diffraction scattering type particle size analyzer.

A tap density of the sulfide-based solid electrolyte may range from 0.5 g/ml to 0.7 g/ml. The tap density may refer to the density value measured from the volume after falling when a 25 ml measuring cylinder is filled with 10 g of sulfide-based solid electrolyte, and the measuring cylinder is fixed, and then tapping and rotation are simultaneously performed 3000 times.

The pellet density of the sulfide-based solid electrolyte may range from 1.65 g/ml to 1.8 g/ml. The pellet density may be refer to the density of a pellet calculated from the difference between the height of the initial empty pelletizer and the height of the pelletizer when a pressure of 3 Mt is applied to the pelletizer for 10 seconds after 1 g of sulfide-based solid electrolyte is injected into a cylindrical pelletizer with a diameter of 13 mm.

Other forms of the present disclosure will be described in more detail through the following examples. The following examples are merely examples to help the understanding of the present disclosure, and the scope of the present disclosure is not limited thereto.

### Example 1

A sulfide-based solid electrolyte represented as Li₆PS₅Cl was produced by the following method.

A raw material was prepared by weighing Li₂S, P₂S₅ and LiCl in a mass ratio of 5:1:2.

The raw material was added so that the solid content of the starting material was about 20%. First, 3 L of tetrahydrofuran was put into a 5 L glass flask and a stirrer was operated. It was confirmed that the color changed from transparent orange to green by adding Li₂S and P₂S₅ during the stirring. When the solution was green, LiCl was added and a starting material was prepared by the stirring for about 12 hours.

The starting material was spray dried using a spray dryer as shown in FIG. 2. First, the chamber was adjusted to about 180° C. The inside of the chamber was filled with argon gas, so that the internal pressure of the chamber was adjusted to about 1.3 atm. In the above state, the starting material was sprayed into the chamber using the nozzle atomizer. The quantity of spray of the starting material was adjusted to about 70 ml/min. Spray drying was performed for about 1.5 seconds, obtaining an intermediate in the form of a white powder.

After heating a heat treatment furnace to about 400° C. at a speed of rising temperature of about 100° C./hr, the intermediate was inputted while maintaining the temperature. The sulfide-based solid electrolyte was produced by heat treating the intermediate for about 12 hours.

### Example 2

A sulfide-based solid electrolyte was produced in the same manner as in Example 1, except that the spray drying temperature was changed to 200° C.

### Example 3

A sulfide-based solid electrolyte was produced in the same manner as in Example 1, except that the spray drying temperature was changed to 220° C.

### Example 4

A sulfide-based solid electrolyte was produced in the same manner as in Example 1, except that the spray drying temperature was changed to 240° C.

### Comparative Example 1

An intermediate was obtained by drying the same starting material as in Example 1 with a heating mantle at about 180° C. until it became a white powder form.

A sulfide-based solid electrolyte was produced by heat treating the intermediate in the same manner as in Example 1.

### Comparative Example 2

A sulfide-based solid electrolyte was produced in the same manner as in) Comparative Example 1, except that the temperature of the heating mantle was differently set to 200° C.

### Comparative Example 3

A sulfide-based solid electrolyte was produced in the same manner as in Comparative Example 1, except that the temperature of the heating mantle was differently set to 220° C.

### Comparative Example 4

A sulfide-based solid electrolyte was produced in the same manner as in Comparative Example 1, except that the temperature of the heating mantle was differently set to 240° C.

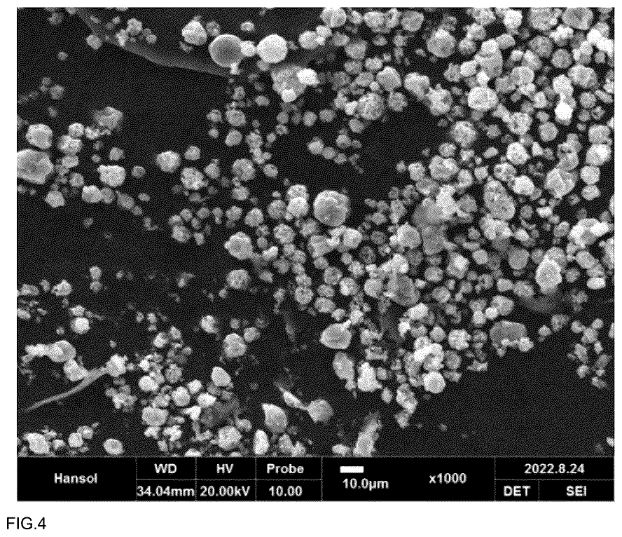

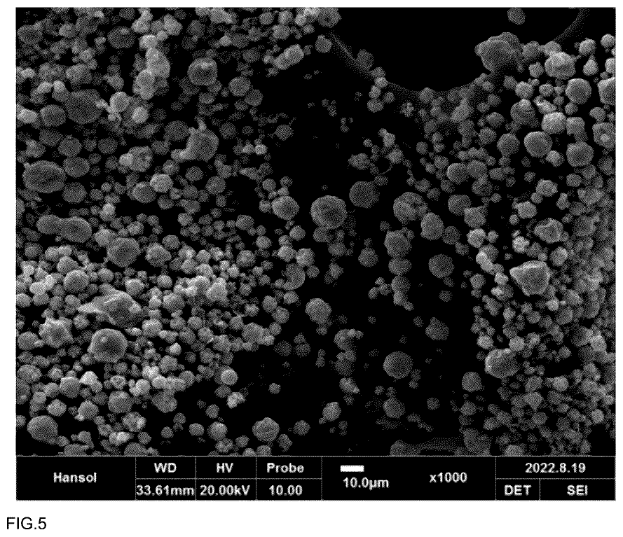

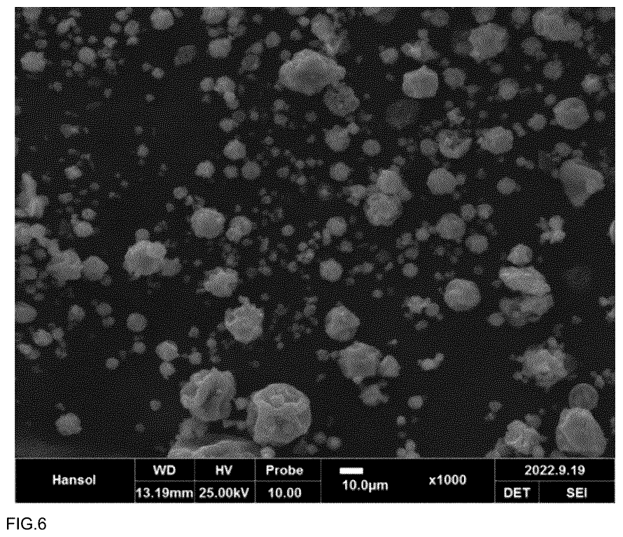

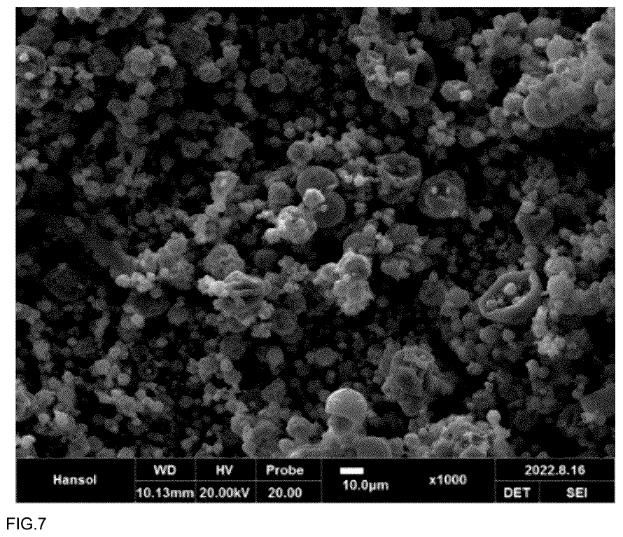

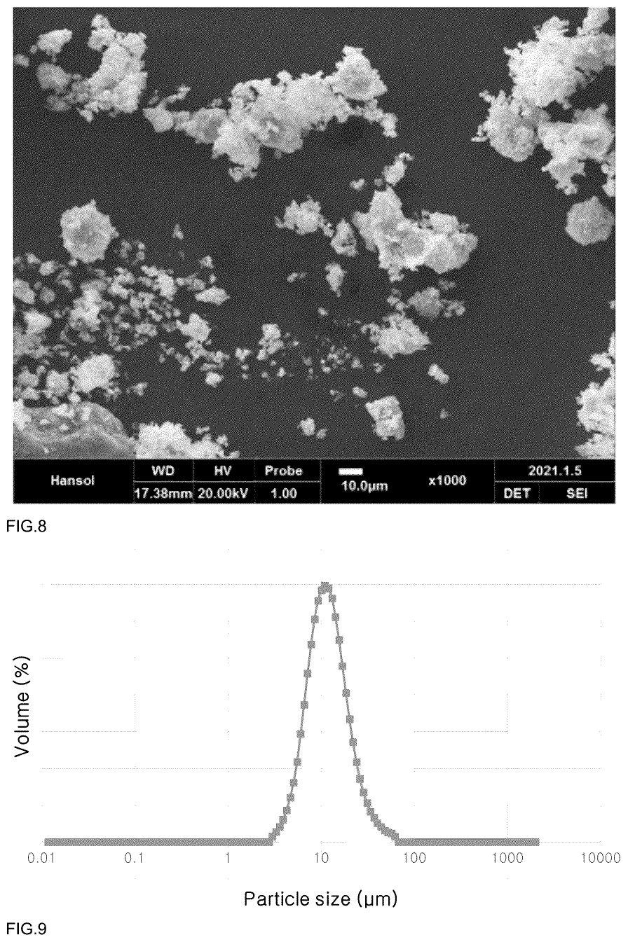

FIG. 4 is a result of observing the sulfide-based solid electrolyte according to Example 1 with a scanning electron microscope. FIG. 5 is a result of observing the sulfide-based solid electrolyte according to Example 2 with a scanning electron microscope. FIG. 6 is a result of observing the sulfide-based solid electrolyte according to Example 3 with a scanning electron microscope. FIG. 7 is a result of observing the sulfide-based solid electrolyte according to Example 4 with a scanning electron microscope. FIG. 8 is a result of observing the sulfide-based solid electrolyte according to Comparative Example 1 with a scanning electron microscope. Referring to FIGS. 4 to 8, it can be seen that the sulfide-based solid electrolytes according to Examples 1 to 4 have a generally uniform spherical particle size, whereas the sulfide-based solid electrolyte according to Comparative Example 1 has a non-uniform particle size distribution, and a mixture of spherical and plate-shaped particles.

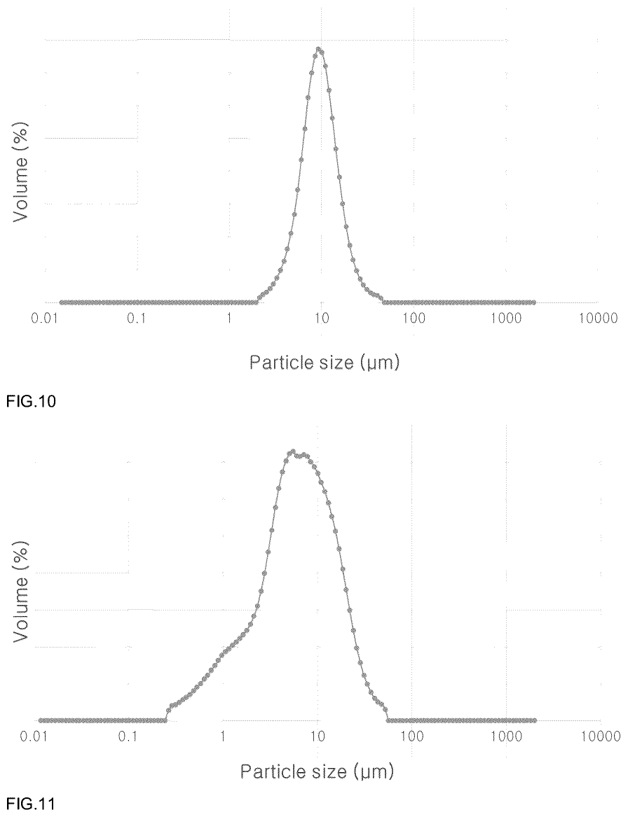

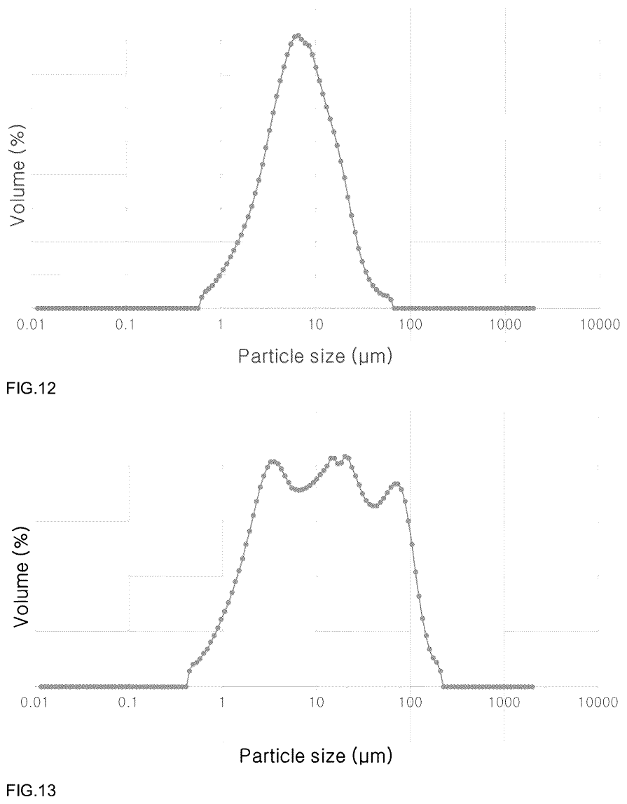

FIG. 9 is the measurement result of the particle size distribution of the sulfide-based solid electrolyte according to Example 1. FIG. 10 is the measurement result of the particle size distribution of the sulfide-based solid electrolyte according to Example 2. FIG. 11 is the measurement result of the particle size distribution of the sulfide-based solid electrolyte according to Example 3. FIG. 12 is the measurement result of the particle size distribution of the sulfide-based solid electrolyte according to Example 4. FIG. 13 is the measurement result of the particle size distribution of the sulfide-based solid electrolyte according to Comparative Example 1. Based on the above results, D50, (D90-D10)/D50 of each sulfide-based solid electrolyte were calculated and shown in Table 1 below.

TABLE 1

| | | | | | Comparative |
|---|---|---|---|---|---|
| Item | Example 1 | Example 2 | Example 3 | Example 4 | Example 1 |
| D10[μm] | 4.61 | 4.87 | 1.23 | 1.99 | 1.76 |
| D50[μm] | 7.78 | 8.98 | 5.8 | 6.42 | 11.61 |
| D90[μm] | 13.34 | 16.37 | 17.46 | 18.58 | 74.58 |
| Dmax[μm] | 30.91 | 43.66 | 51.96 | 61.73 | 207.7 |
| (D90 − | 1.12 | 1.28 | 2.8 | 2.58 | 6.27 |
| D10)/D50 | | | | | |

Referring to FIGS. 9 to 13 and Table 1, it can be seen that since the sulfide-based solid electrolytes according to Examples 1 to 4 show lower (D90-D10)/D50 values than the sulfide-based solid electrolyte according to Comparative Example 1, a sulfide-based solid electrolyte having a uniform particle size distribution can be obtained according to the present disclosure.

Table 2 shows the results of measuring the tap densities of the sulfide-based solid electrolytes according to Examples 1, 2, and 4 and Comparative Examples 1 to 4. The tap density was measured twice and averaged for each sulfide-based solid electrolyte.

TABLE 2

Tab density [g/ml]

| Classification | First time | Second time | Average |
|---|---|---|---|
| Example 1 | 0.656 | 0.658 | 0.657 |
| Example 2 | 0.668 | 0.649 | 0.659 |
| Example 4 | 0.59 | 0.594 | 0.592 |
| Comparative Example 1 | 0.487 | 0.485 | 0.486 |
| Comparative Example 2 | 0.463 | 0.462 | 0.463 |
| Comparative Example 3 | 0.436 | 0.437 | 0.437 |
| Comparative Example 4 | 0.498 | 0.487 | 0.493 |

Table 3 shows the results of measuring the pellet densities of the sulfide-based solid electrolytes according to Examples 1, 2, and 4 and Comparative Examples 1 to 4. The pellet density was measured twice and averaged for each sulfide-based solid electrolyte.

TABLE 3

Pellet density [g/ml]

| Classification | First time | Second time | Average |
|---|---|---|---|
| Example 1 | 1.771 | 1.748 | 1.760 |
| Example 2 | 1.761 | 1.752 | 1.757 |
| Example 4 | 1.702 | 1.69 | 1.696 |
| Comparative Example 1 | 1.542 | 1.58 | 1.561 |
| Comparative Example 2 | 1.578 | 1.57 | 1.574 |
| Comparative Example 3 | 1.611 | 1.6 | 1.606 |
| Comparative Example 4 | 1.561 | 1.578 | 1.570 |

Referring to Tables 2 and 3, it can be seen that the sulfide-based solid electrolytes according to the Examples have higher tap densities and higher pellet densities than those according to the Comparative Examples.

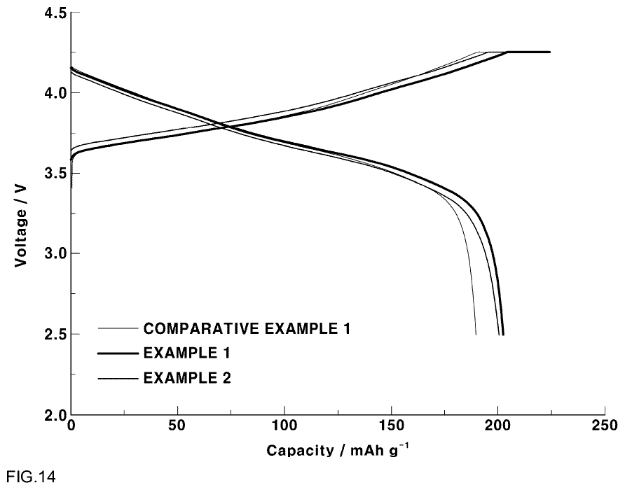

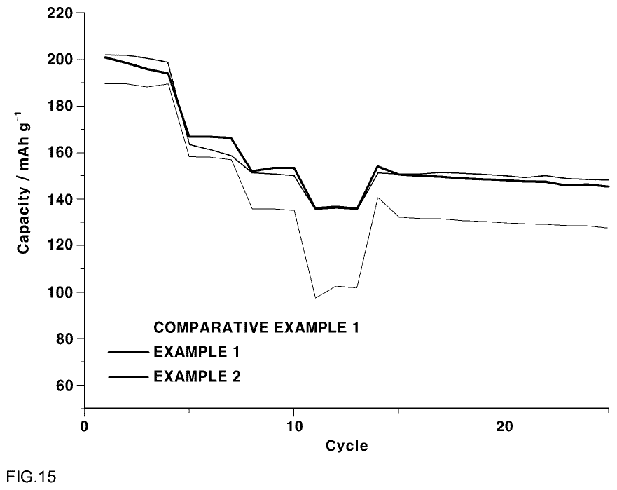

FIG. 14 is a cyclic voltammetry evaluation result of the performances of all-solid-state batteries manufactured using the sulfide-based solid electrolytes according to Examples 1, 2, and Comparative Example 1. The evaluation condition was adjusted to 0.1C and 2.5-4.2V. The charge capacity of the all-solid-state battery according to Example 1 is about 221 mAh/g, and the discharge capacity thereof is about 205 mAh/g. The charge capacity of the all-solid-state battery according to Example 2 is about 223 mAh/g, and the discharge capacity thereof is about 202 mAh/g. The charge capacity of the all-solid-state battery according to Comparative Example 1 is about 220 mAh/g, and the discharge capacity thereof is about 183 mAh/g. Examples 1 and 2 are superior to Comparative Example 1 in terms of both charge capacity and discharge capacity.

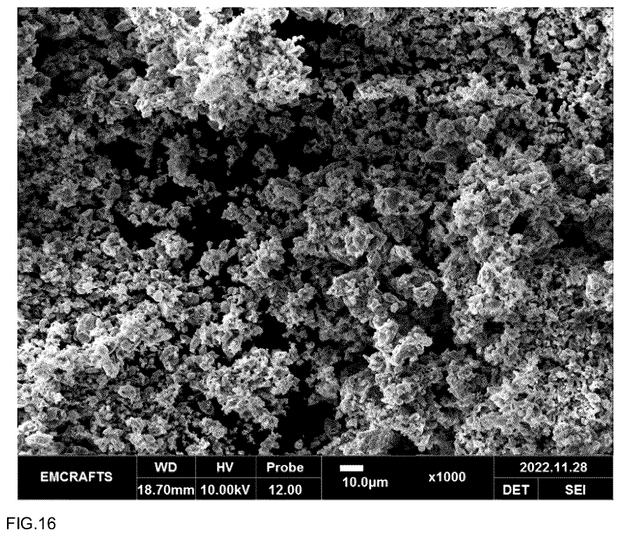

FIG. 15 shows capacities measured while charging and discharging all-solid-state batteries manufactured using sulfide-based solid electrolytes according to Examples 1, 2, and Comparative Example 1. The measurement was performed while C-rate was adjusted to 0.1 C, 0.33 C, 0.5 C, 1 C, and then 0.5 C. It can be seen that both Example 1 and Example 2 show excellent results compared to Comparative Example 1.

### Comparative Example 5

A sulfide-based solid electrolyte was produced in the same manner as in Example 1 above, except that the solid content of the starting material was adjusted to be less than 10% by weight.

### Comparative Example 6

A sulfide-based solid electrolyte was produced in the same manner as in Example 1 above, except that the solid content of the starting material was adjusted to be greater than 30% by weight.

FIG. 16 is a result of analyzing the sulfide-based solid electrolyte according to Comparative Example 5 with a scanning electron microscope. Referring to this, it can be seen that Comparative Example 5 is not spherical and its shapes are very non-uniform because the solid content of the starting material is low.

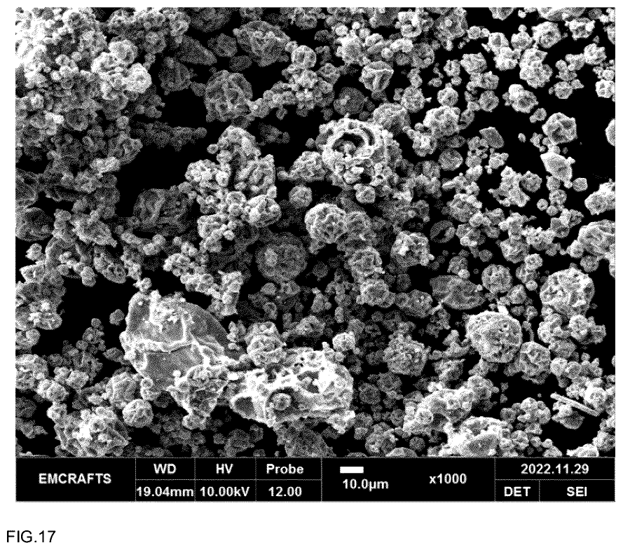

FIG. 17 is a result of analyzing the sulfide-based solid electrolyte according to Comparative Example 6 with a scanning electron microscope. Referring to this, it can be seen that Comparative Example 6 has a large particle size and lumped particles because the solid content of the starting material is high.

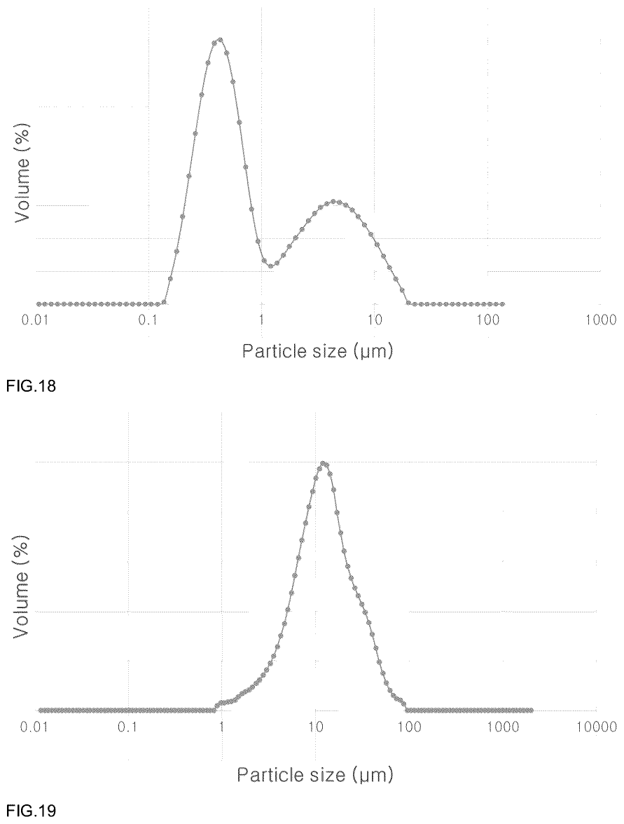

FIG. 18 is the measurement result of the particle size distribution of the sulfide-based solid electrolyte according to Comparative Example 5. FIG. 19 is the measurement result of the particle size distribution of the sulfide-based solid electrolyte according to Comparative Example 6. Based on the above results, the D50 of each sulfide-based solid electrolyte was calculated and shown in Table 4 together with the results of Example 1.

TABLE 4

| | | Comparative | Comparative |
|---|---|---|---|
| Item | Example 1 | Example 5 | Example 6 |
| D10[μm] | 4.61 | 0.26 | 4.15 |
| D50[μm] | 7.78 | 0.619 | 11.49 |
| Dmax[μm] | 30.91 | 18.7 | 87.99 |

Referring to FIGS. 9, 18, and 19, it can be seen that the sulfide-based solid electrolyte according to Example 1 has a more even particle size distribution than Comparative Examples 5 and 6.

While the experimental examples and implementations of the present disclosure have been described in detail above, the scope of the present disclosure is not limited thereto, but various modifications and improvements which could be made by those skilled in the art using the basic concept of the present disclosure defined in the following claims would also fall within the scope of the present disclosure.

What is claimed is:

1. A method of producing a solid electrolyte, the method comprising:
preparing a raw material comprising one or more of a lithium (Li) element, a phosphorus (P) element, or a sulfur(S) element;
preparing a starting material comprising the raw material and a solvent;
obtaining an intermediate in powder form by spray drying the starting material; and
obtaining a sulfide-based solid electrolyte by heat treating the intermediate.

2. The method of claim 1, wherein the raw material includes Li₂S and P₂S₅.

3. The method of claim 1, wherein the raw material further comprises a lithium compound comprising a halogen element.

4. The method of claim 1, wherein the solvent comprises tetrahydrofuran (THF).

5. The method of claim 1, wherein the starting material has a solid content in an amount of 10% by weight to 30% by weight.

6. The method of claim 1, wherein the obtaining of the intermediate comprises spraying the starting material into a chamber of a spray dryer through a nozzle atomizer.

7. The method of claim 6, wherein an evaporation quantity of the chamber ranges from 1 kg/hr to 4 kg/hr.

8. The method of claim 6, wherein the starting material is sprayed into the chamber at a spray rate of 50 ml/min to 70 ml/min.

9. The method of claim 6, wherein an internal pressure of the chamber ranges from 1.3 atm to 1.5 atm.

10. The method of claim 6, wherein the spray dryer comprises:
a chamber defining an internal space of a preset size;
a nozzle atomizer connected to the chamber and configured to spray the starting material;
a first compressor connected to the nozzle atomizer and configured to supply a carrier gas;
a second compressor connected to the chamber and configured to supply a gas to thereby adjust an internal pressure of the chamber;
a sensor mounted in the chamber and configured to measure the internal pressure of the chamber;
a vent valve configured to discharge the carrier gas in the chamber to an outside of the chamber; and
a controller connected to the second compressor and the vent valve and configured to control whether to operate the second compressor and the vent valve based on the internal pressure of the chamber measured by the sensor.

11. The method of claim 1, wherein the obtaining of the intermediate is performed in a temperature of 180° C. to 240° C.

12. The method of claim 1, wherein the obtaining of the intermediate comprises spray drying the starting material for 1 second to 5 seconds.

13. The method of claim 1, wherein the obtaining of the sulfide-based solid electrolyte comprises heat treating the intermediate in a temperature of 300° C. to 500° C. for 12 hours to 48 hours.

14. The method of claim 1, wherein D50 of the sulfide-based solid electrolyte ranges from 5 μm to 10 μm.

15. The method of claim 1, wherein (D90-D10)/D50 of the sulfide-based solid electrolyte ranges from 1 to 3.

16. The method of claim 1, wherein a tap density of the sulfide-based solid electrolyte ranges from 0.5 g/ml to 0.7 g/ml.

17. The method of claim 1, wherein a pellet density of the sulfide-based solid electrolyte ranges from 1.65 g/ml to 1.8 g/ml.
